(19) United States
(12) Patent Application Publication
(10) Pub. No.: US 2011/0015999 A1
(43) Pub. Date: Jan. 20, 2011

(54) SYSTEM AND METHOD FOR UTILIZING A LATTICE STORAGE STRUCTURE IN AN ADVERTISEMENT SERVING SYSTEM

(75) Inventors: Sergei Vassilvitskii, New York, NY (US); Erik Vee, San Mateo, CA (US); Jayavel Shanmugasundaram, Santa Clara, CA (US); Srinivasan Rajagopal, San Jose, CA (US); Ramana Yerneni, Cupertino, CA (US); Chad Brower, San Jose, CA (US)

Correspondence Address: YAHOO! INC.;C/O Ostrow Kaufman LLP, The Chrysler Building, 405 Lexington Avenue, 62nd Floor, NEW YORK, NY, 10174, US

(73) Assignee: YAHOO! INC., Sunnyvale, CA (US)

(21) Appl. No.: 12/502,330

(22) Filed: Jul. 14, 2009

(51) Int. Cl. G06Q 30/00

(52) U.S. Cl. 705/14.52; 705/14.49; 705/14.69

(57) ABSTRACT

Embodiments of the present invention provide for methods, systems and computer program products for utilizing a lattice structure in an advertisement serving system. The method according to one embodiment of the present invention comprises storing one or more advertisement contracts in a lattice structure. A request for one or more advertisements that satisfy one or more constraints is then received and within the lattice structure, a lowest level of one or more pools of advertisement contracts satisfying the one ore more constraints is located. A set of advertisement contracts is generated, wherein the set of advertisement contracts comprise one or more advertisement contracts from lowest level of the lattice structure. The method further comprises adding to the set of advertisement contracts advertisement contracts from the pools of advertisement contracts that are parent to the pools of contracts in the lowest level of the lattice structure.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent files or records, but otherwise reserves all copyright rights whatsoever.

### FIELD OF THE INVENTION

The invention disclosed herein relates generally to advertisement tags. More specifically, the present invention provides systems, methods and computer program products for utilizing a lattice structure in an advertisement serving system.

### BACKGROUND OF THE INVENTION

The World Wide Web provides access to an extraordinary large collection of information resources (in various formats including text, images, videos, other media content and combinations thereof) relating to virtually every subject imaginable. Advertising has become the economic foundation of the World Wide Web, with many websites relying on revenue generated by the placement of advertisements on website as a primary or otherwise important source of income. Traditionally, advertisers have a pre-existing agreement, known as an advertisement contract, with an advertisement provider to display online advertisements in association with one or more selected content items. Web pages usually display online advertisements as a result of a request for one or more advertisements by advertisement tags that are associated with content items that a given publisher provides. The requests for advertisements, as well as the subsequent selection of advertisements for display on content items (such as web pages) are usually handled by an ad serving system.

As online advertising continues to grow, the number of available advertisement contracts that are to be satisfied by advertisement providers has also grown at a commensurate rate. For advertisement providers to be able to efficiently satisfy obligations under a large number of advertisement contracts, an advertisement provider is in need of systems and methods that effectively and quickly locate advertisement contracts are to be satisfied when presented with an advertisement opportunity.

### SUMMARY OF THE INVENTION

Generally, embodiments of the present invention provide for methods, systems and computer program products for utilizing a lattice structure in an advertisement serving system. One embodiment of the present invention is directed towards a method for utilizing a lattice structure in an advertisement serving system that comprises storing one or more advertisement contracts in a lattice structure. A request for one or more advertisements that satisfy one or more constraints is received and within the lattice structure, a lowest level of one or more pools of advertisement contracts satisfying the one ore more constraints is located. A set of advertisement contracts is generated, wherein the set of advertisement contracts comprises one or more advertisement contracts from the one or more pools of contracts in the lowest level of the lattice structure that satisfy the one or more constraints. The method further comprises adding to the set of advertisement contracts one or more advertisement contracts from one or more pools of advertisement contracts that are parent to the one or more pools of contracts in the lowest level of the lattice structure that satisfy the one or more constraints and returning one or more advertisement contracts that satisfy the one or more constraints.

In utilizing a lattice structure in an advertisement serving system, embodiments of the present invention provide solutions to the need for systems and methods that effectively and quickly locate advertisement contracts that are to be satisfied when presented with an advertisement opportunity.

### BRIEF DESCRIPTION OF THE DRAWINGS

The invention is illustrated in the figures of the accompanying drawings which are meant to be exemplary and not limiting, in which like references are intended to refer to like or corresponding parts, and in which:

FIG. 1 illustrates a block diagram of a system for utilizing a lattice storage structure in an advertisement serving system according to one embodiment of the present invention;

FIG. 2 illustrates a flow diagram presenting a method for storing advertisement contracts in an advertisement serving system according to one embodiment of the present invention;

FIG. 3 illustrates a diagram presenting a sample lattice structure for storage of advertisement contracts in an advertisement serving system according to one embodiment of the present invention;

FIG. 4 illustrates a flow diagram presenting a method for utilizing a lattice storage structure in an advertisement serving system according to one embodiment of the present invention; and

FIG. 5 illustrates a flow diagram presenting an alternative method for utilizing a lattice storage structure in an advertisement serving system according to one embodiment of the present invention.

### DETAILED DESCRIPTION OF THE INVENTION

In the following description of the embodiments of the invention, reference is made to the accompanying drawings that form a part hereof, and in which is shown by way of illustration, exemplary embodiments in which the invention may be practiced. It is to be understood that other embodiments may be utilized and structural changes may be made without departing from the scope of the present invention.

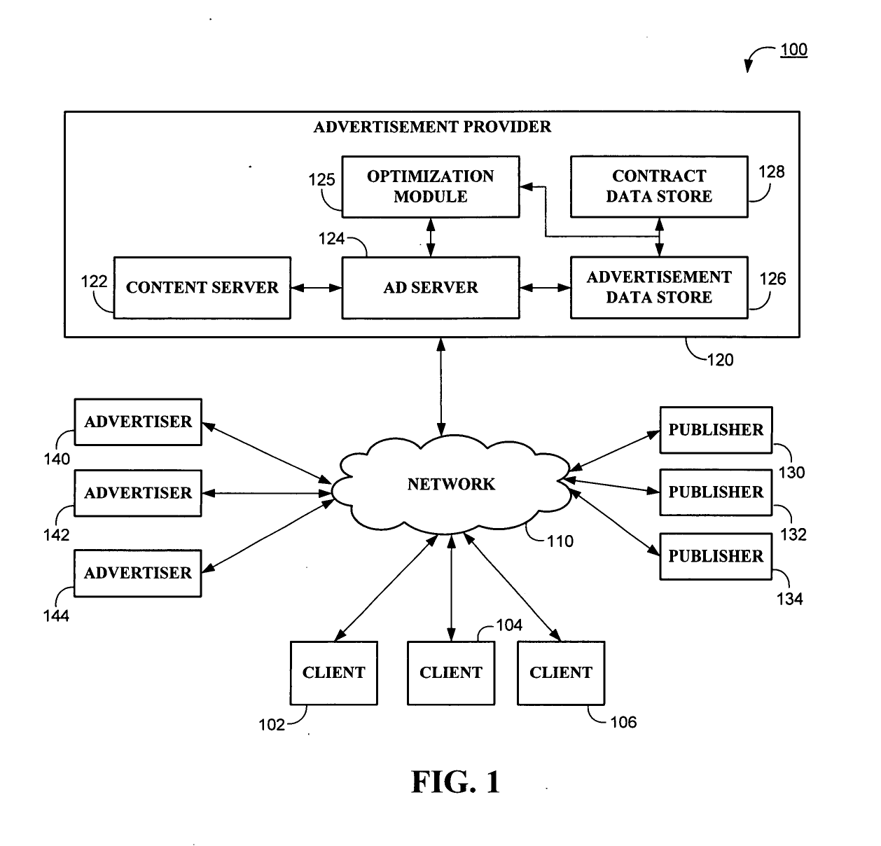

FIG. 1 illustrates one embodiment of a system 100 for utilizing a lattice storage structure in an advertisement serving system. The system 100 according to FIG. 1 includes a computer network 110, an advertisement provider 120, a first client 102, a second client 104 and a third client 106, a first publisher 130, a second publisher 132 and a third publisher 134, a first advertiser 140, a second advertiser 142 and a third advertiser 144. In the present embodiment, the advertisement provider 120 comprises a content server 122, an ad server 124, an optimization module 125, an advertisement data store 126 and a contract data store 128.

The computer network 110 may be any type of computerized network capable of transferring data, such as the Internet. According to one embodiment of the invention, the first client device 102, the second client device 104 and the third client device 106 are general purpose personal computers comprising a processor, transient and persistent storage devices, input/output subsystem and bus to provide a communications path between components comprising the general purpose personal computer. Other client devices are considered to fall within the scope of the present invention including, but not limited to, hand held devices, set top terminals, mobile handsets, PDAs, etc. The present invention is not limited to only the client devices 102, 104 and 106 and may comprise additional, disparate client devices. The client devices 102, 104 and 106 are therefore presented for illustrative purposes representative of multiple client devices.

According to one embodiment of the invention, the content server 122, the ad server 124, the publishers 130, 132 and 134, the advertisers 140, 142 and 144 are programmable processor-based computer devices that include persistent and transient memory, as well as one or more network connection ports and associated hardware for transmitting and receiving data on the network 110. The content server 122, ad server 124, the publishers 130, 132 and 134, the advertisers 140, 142 and 144 and the ad server 150 may host websites, store data, serve ads, etc. Those of skill in the art understand that any number and type of content server 122, ad server 124, publishers 130, 132 and 134, and advertisers 140, 142 and 144 may be connected to the network 110.

The optimization module 125 may comprise one or more processing elements operative to perform processing operations in response to executable instructions, collectively as a single element or as various processing modules, which may be physically or logically disparate elements. The advertisement data store 126 and the contract data store 128 may be one or more data storage devices of any suitable type that are operative to persistently store corresponding data therein. Those of skill in the art recognize that the advertisement provider 120 may utilize more or fewer components and data stores and that a given component or data store comprising the advertisement provider 120 may be local or remote with regard to another given component or data store.

In accordance with one embodiment, client devices 102, 104 and 106, publishers 130, 132 and 134, advertisers 140, 142, and 144, and the advertisement provider 120 are communicatively coupled to the computer network 110. In accordance with one embodiment, advertisers 140, 142, and 144 may communicate across the network 110 to submit a request to the advertisement provider 120 for one or more advertisement contracts specifying a specific target. More specifically, the advertisers' request for an advertisement target may specify certain contextual constraints for an advertisement opportunity on a web document that is to be viewed by an end user satisfying such constraints. For example, the advertisers' request may specify that the advertisement target should be California males in age group 18-25 with an interest in sports. The advertisers 140, 142, and 144 may book the one or more advertisement contracts through the content sever 122 of the advertisement provider 120, which is subsequently transmitted to the ad server 124. According to one embodiment, the content server 122 maintains an interface through which the advertisers 140, 142 and 144 may communicate with the advertiser provider 120 to book the one or more advertisement contracts. The contract data store 128 may maintain the one or more advertisement contracts, with a given advertisement contract encoded with or otherwise specifying the constraints for the target.

The client devices 102, 104 and 106 may display one or more web documents maintained by the publishers 130, 132 and 134, such as a news website, an online shopping website, an auction website, a blog website, etc. The one or more web documents displayed on the client device 102, 104 and 106 may contain data indicating the existence of an advertisement opportunity where an advertisement may be displayed on a given web document. The advertisement opportunity may include information about a user viewing the web document, a URL of the web page being accessed by the user, etc.

The client devices 102, 104 and 106 may then communicate across the network 110 with the advertisement provider 120, by transmitting the advertisement opportunity. Specifically, the client devices 102, 104 and 106 may transmit one or more requests for advertisements to the ad server 124 of the advertisement provider 120. According to one embodiment, the ad server 124 receives an allocation plan from the optimization module 125, which the ad server 124 may receive in a periodic manner, for use in responding to advertisement opportunities. Accordingly the ad server 124 may respond to advertisement opportunities without contacting the optimization module 125 for a given advertisement opportunity.

As is described in greater detail herein, the ad server 124 may use the methods of the present invention for the purpose of matching advertisement contracts with advertisement opportunities, whereas the optimization module 125 may create an allocation plan by matching historical advertisement opportunities with one or more current advertisement contracts. According to one embodiment, the ad server 124 is operative to perform the functions of the optimization module 125 whereas according to other embodiments the ad server 124 incorporates the functions of the optimization module 125 as various combinations of one or more hardware or software components.

Upon receipt of the advertisement opportunity, the optimization module 125 may search the repository of advertisement contracts stored in the contract data store 128. The contract data store 128 may include one or more advertisement contracts that contain contractual information usable by the advertising system 100 relating to terms and conditions for the placement of one or more advertisements that are requested as the advertisement opportunity. Specifically, the contractual information may include, in part, certain requirements, referred to as contextual constraints, which serve to indicate that a target audience that the advertiser is seeking in the advertisement contract. As presented previously, an advertisement contract may specify, for example, that the advertisement target should be California males in age group 18 to 25 years old with an interest in sports.

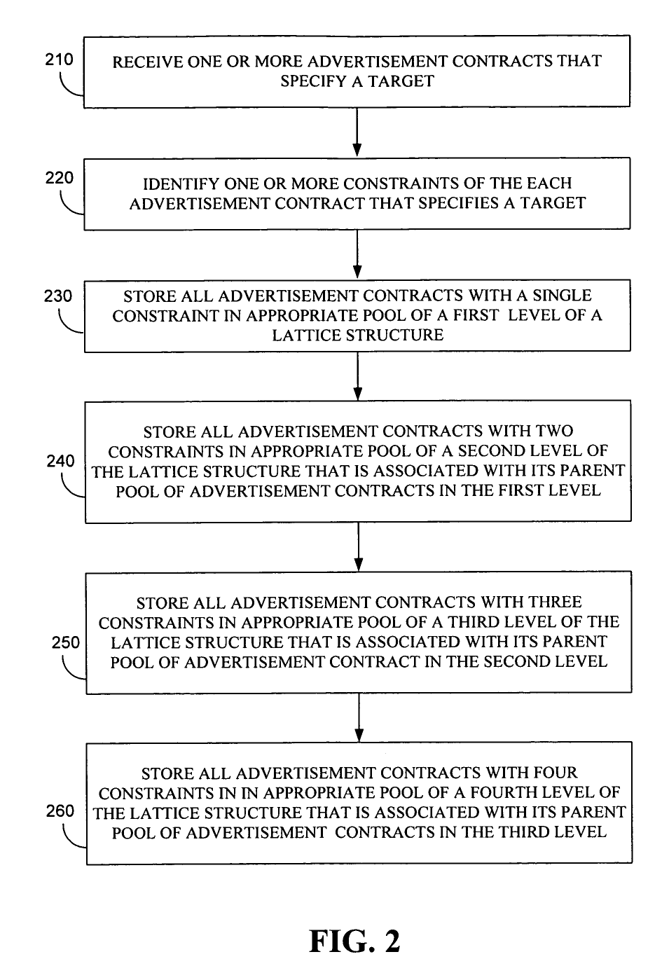

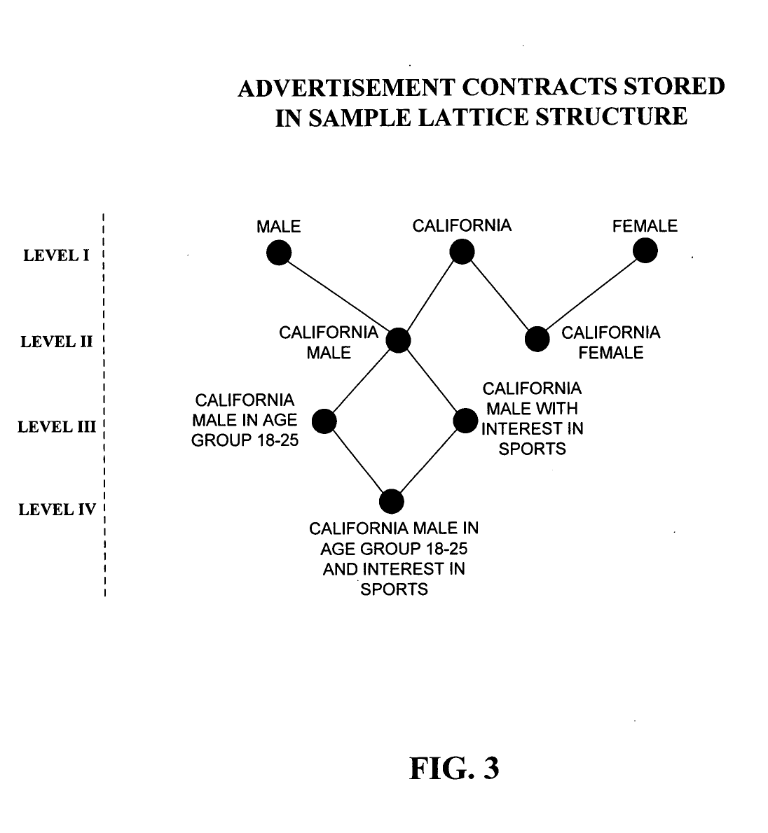

The contract data store 128 may store the one or more advertisement contracts in a lattice structure that comprises multiple levels of advertisement contracts. A given level of advertisement contracts may be distinguished by the number of constraints the advertisement contracts contained therein require to be satisfied. For example, a lattice storage structure of advertisement contracts may be organized so that the first or top level in the lattice structure contain advertisement contracts that are subject to a single constraint, a second level where children advertisement contracts are subject to two constraints and so on. It should be noted by those of skill in the art that subsequent levels in the lattice structure may comprise advertisement contracts with multiple constraints, so long as the multiple constraints are a superset of the constraints on the advertisement contracts at the parent level. For example, building on the prior illustration, a second level in the lattice structure may comprise children advertisement contracts that are subject to three or more constraints, so long as those constraints are a superset of the constraints of the advertisement contracts at the top level of the lattice. Methods for generating the lattice storage structure of advertisement contracts and a further description of the lattice storage structure are described in greater detail with respect to FIGS. 2 and 3, respectively.

Associated with a given advertisement contract in the contract data store 128 are one or more advertisements provided by the advertisers 140, 142 and 144, which are stored in the advertisement data store 126 of the advertisement provider 120. The optimization module 125 is operative to select and transmit to the ad server 124, one or more advertisement contracts associated with the one or more advertisements in the advertisement data store 126. The ad server 124 subsequently serves or transmits the one or more advertisements associated with the selected one or more advertisement contracts to the given requesting client device 102, 104 or 106 via the network 110 to be displayed with web document of the publisher 130, 132 or 134 that is displayed to an end user of the client device 102, 104 or 106.

According to one embodiment of the present invention, in order for the optimization module 125 to select one or more advertisement contracts that are responsive to targeted request for advertisements, or advertisement opportunities, the optimization module identifies certain information provided by the advertisement opportunity. Continuing from the previous example, the optimization module 125 identifies that the advertisement opportunity is for a California male in age group 18-25 years old with an interest in sports. The optimization module 125 is operative to then search the repository of advertisement contracts stored in the contract data store 128 in order to identify those advertisement contracts that may be satisfied by the advertisement opportunity.

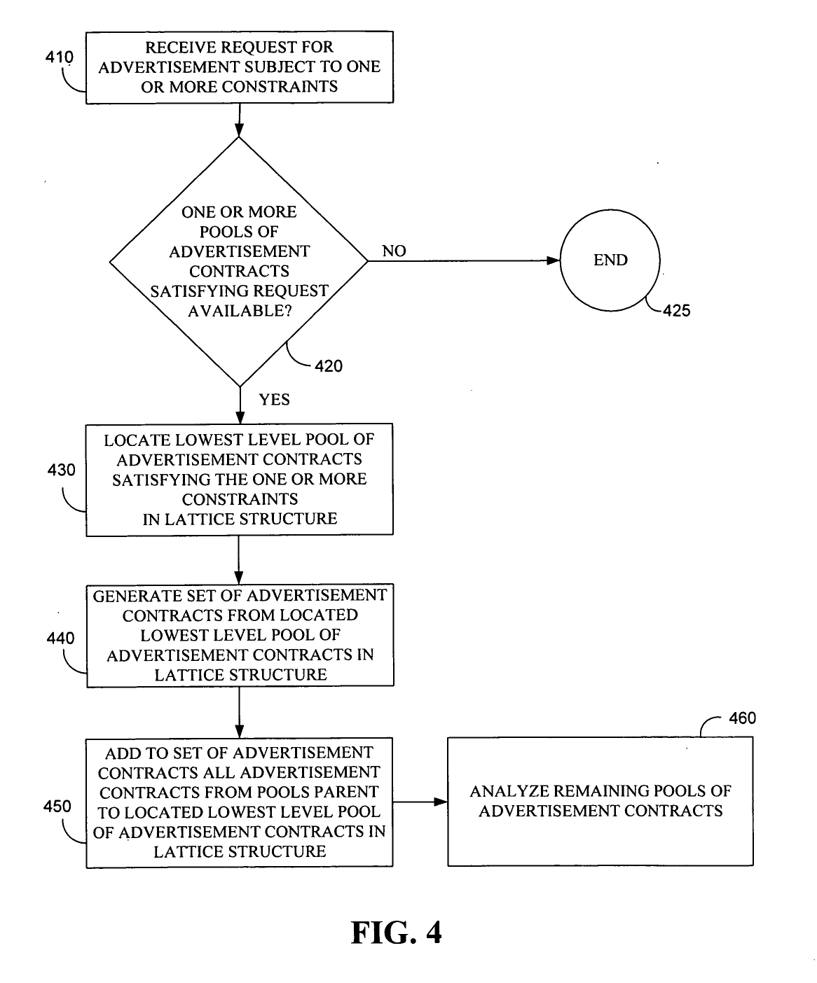

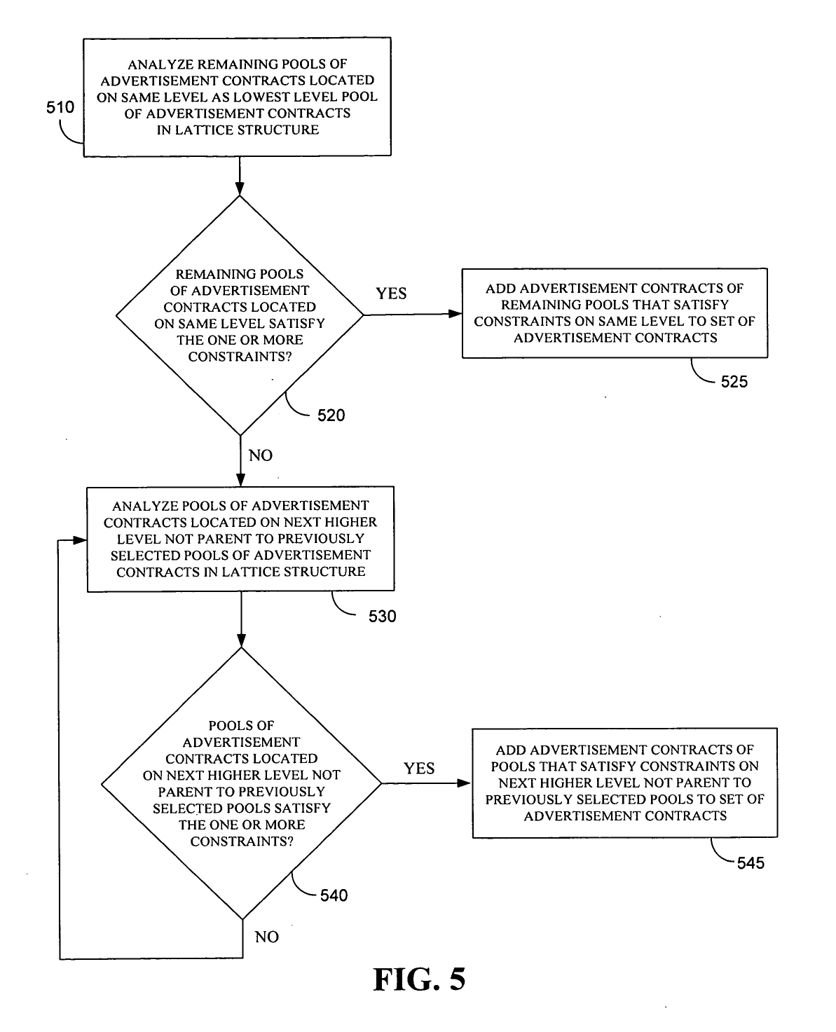

As presented previously, the advertisement contracts are stored in the contract data store 128 in a lattice structure that comprises multiple levels of advertisement contracts. Continuing from the previous example, the optimization module 125 may identify multiple advertisement contracts within the lattice structure that specify that the target should be a California male in age group 18 to 25 years old with an interest in sports. Methods for traversing the lattice storage structure of advertisement contracts in order to locate and select responsive advertisement contracts are described in greater detail with respect to FIGS. 4 and 5.

The optimization module 125 is operative to aggregate the satisfying advertisement contracts into a set or pool of active advertising contracts. For example, the optimization module 125 may aggregate advertisement contracts with the constraints of a California male in age group 18 to 25 years old with an interest in sports. The optimization module 125 may also pass the set of advertisement contracts to the ad server 124, who may then locate and return to the client devices 102, 104 and 106 one or more advertisements associated with the one or more advertisement contracts. As presented previously, the one or more advertisements associated with the one or more advertisement contracts that satisfy the one or more constraints, are stored in the advertisement data store 126 of the advertisement provider 120.

FIG. 2 illustrates a flow diagram presenting a method for storing advertisement contracts in an advertisement serving system according to one embodiment of the present invention. In accordance with the embodiment of FIG. 2, the method may begin by receiving one or more advertisement contracts that specify a target, step 210. For example, a California-based vitamin supplement company may have an on-line advertising campaign where the target audience for their on-line advertisements are males who reside in California, are of the age group 18 to 25 years old and who have an interest ins sports. The California-based vitamin supplement company may enter into an agreement, known as an advertisement contract, with a search provider to display online advertisements in association with one or more selected web pages specifying the target audience as California males in age group 18 to 25 years old who have an interest in sports. In another example, the national vitamin supplement company may require an advertisement contract where the target is just male persons.

The one or more constraints of a given advertisement contract that specifies a target is identified, step 220. Continuing from the initial example, the constraints for the advertisement contract would be male person, California resident, age group 18 to 25 years old and interest in sports; while in the latter example, the advertisement contract would have a single constraint of a male person. Advertisements subject to a single constraint are stored in the appropriate pool of a first level of a lattice structure, step 230. For example, as presented previously, a national vitamin supplement company may require an advertisement contract where the target is only male persons and thus there is a single constraint of male persons. Such an advertisement contract and the like would be stored in the appropriate pool of the first level of the lattice structure. According to one embodiment, the advertising contracts in a given level of the lattice structure are grouped into sets or pools that correspond to their respective constraint. Continuing from the previous example, the advertisement contract of the national vitamin supplement company would be stored in the pool of advertisement contracts on the first level that require the constraint of a male person. The first level may have multiple pools in the first level, and subsequent levels, such as a pool of advertisement contracts that require the constraint of a California resident or a female person.

Advertisements subject to two constraints are then stored in the appropriate pool in a second level of the lattice structure that is associated with its parent pool of advertisements contract in the first level, step 240. For example, a California-based men's clothing company may require an advertisement contract where the target is California male persons and thus there exist two constraints of male persons and California residents. Such an advertisement contract and the like would be stored in the appropriate pool of the second level of the lattice structure. For example, the advertisement contract for the California-based men's clothing company may be stored in the pool of advertisement contracts on the second level that require the constraint of a male person and a California resident. The pool of advertisement contracts on the second level that require the constraint of a male person and a California resident is associated with its parent pool of advertisement contracts on the first level, i.e. the pool of advertisement contracts that require the constraint of a male person and the pool of advertisement contracts that require the constraint of a California resident.

Advertisements subject to three constraints are then stored in the appropriate pool in a third level of the lattice structure that is associated with its parent pool of advertisement contracts in the second level, step 250. For example, a California-based computer company may require an advertisement contract where the target is California male persons who attend an undergraduate university and thus in the age group of 18 to 25 years old. The result is the requirement of three constraints: male persons, California residents and age group 18-25 years old. Such an advertisement contract and the like would be stored in the appropriate pool of the third level of the lattice structure. For example, the advertisement contract for the California-based computer company may be stored in the pool of advertisement contracts on the third level that require the constraints of a male person, a California resident and age group 18 to 25 years old. The pool of advertisement contracts on the third level that require the constraint of a male person, a California resident and age group 18 to 25 years old is associated with its parent pool of advertisement contracts on the second level, i.e. the pool of advertisement contracts that require the constraint of a male person who is a California resident.

Advertisements subject to four constraints are then stored in the appropriate pool in a fourth level of the lattice structure that is associated with its parent pool of advertisements contract in the third level, step 260. For example, a California-based vitamin supplement company may require an advertisement contract where the target is California males in age group 18 to 25 years old who have an interest in sports. The result is the requirement of four constraints: male persons, California residents, age group 18 to 25 years old and an interest in sports. Such an advertisement contract and the like would be stored in the appropriate pool of the fourth level of the lattice structure. For example, the advertisement contract for the California-based computer company may be stored in the pool of advertisement contracts on the third level that require the constraints of a male person, a California resident and age group 18 to 25 years old. The pool of advertisement contracts on the fourth level that require the constraint of a male person, a California resident, age group 18 to 25 years old and an interest in sports is associated with its parent pools of advertisement contracts on the third level, i.e. the pool of advertisement contracts that require the constraint of a male person who is a California resident in the age group of 18 to 25 years old and the pool of advertisement contracts that require the constraint of a male person who is a California resident and has an interest in sports. According to one embodiment of the present invention, the lattice structure is not limited to solely four levels with the described limited number of pools per level, but may extend to a greater number of levels containing therein a greater number of pools.

FIG. 3 illustrates a diagram presenting a sample lattice structure for storage of advertisement contracts in an advertisement serving system according to one embodiment of the present invention. As set forth in the description of the lattice storage structure with respect to FIG. 2, advertisement contracts may be stored in a lattice structure where the number and types of constraints are determinative of the pool in a certain level where the advertisement contract is stored. FIG. 3 provides a sample illustration of the lattice structure as described with respect to FIG. 2, where a given node in the lattice structure represents a pool of advertisement contract subject to constraints which are described in the accompanying label of a given node. Thus, for example, advertising contracts requiring the constraints of a male person who is California resident in the age group of 18 to 25 years old and has in interest in sports would be stored in the pool located in Level IV. In addition, the node in Level IV representative of the pool of advertising contracts requiring the constraints of a male person who is California resident in the age group of 18 to 25 years old and has in interest in sports is associated with the parent nodes representative of the parent pool of advertising contracts requiring the constraints of a male person who is California resident in the age group of 18 to 25 years old and the parent pool of advertising contracts requiring the constraints of a male person who is California resident who has an interest in sports.

FIG. 4 illustrates a flow diagram presenting a method for utilizing a lattice storage structure in an advertisement serving system according to one embodiment of the present invention. In accordance with the embodiment of FIG. 4, the method may begin by receiving a request for one or more advertisements subject to one or more constraints, step 410. For example, an end user, who is a California male, operating a client device, may access a webpage for a Los Angeles male softball team. According to one embodiment, the end user may have associated with him a user profile that indicates that the end user is a California male who is 23 years old and has an interest in sports. As presented previously, the one or more web documents contain data indicating that there is an advertisement opportunity, which is transmitted to the ad server as a request for an advertisement that is subject to certain constraints, such as from the previous example, a California male who is in age group 18 to 25 years old and has an interest in sports.

A determination is then made as to whether one or more pools of advertisement contracts satisfying the request are available, step 420. For example, the ad server may receive the request for the one or more advertisements subject to certain constraints, which then uses an optimization module to subsequently search its repository of advertisement contracts to determine if there are multiple advertisement contracts that satisfy the request for one or more advertisements that is targeted to California males in age group 18 to 25 years old who have an interest in sports. If one or more pools of advertisement contracts satisfying the request are not available, the method terminates at step 425.

If one or more pools of advertisement contracts satisfying the request are available, process flow continues to step 430, where the lowest level pool of advertisement contracts satisfying the one or more constraints in the lattice structure are located, step 430. Continuing from the previous example, as the constraints required are a male person, who is a California resident in the age group of 18 to 25 years old and has in interest in the sports, the optimization algorithm may search the lattice structure of stored advertisement contracts to locate the pool of advertisement contracts that satisfy one or more of constraints that are also located on the lowest level of the lattice structure. Therefore, within a lattice structure, such as the one depicted in FIG. 3, the pool of advertising contracts targeting California males in age group 18 to 25 years old with an interest in sports would be located.

A set of advertisement contracts is generated, beginning with the located lowest level pool of advertisement contracts in the lattice structure, step 440. Continuing from the previous example, a set of advertisements contracts within the pool of advertising contracts targeting California males in age group 18 to 25 years old with an interest in sports located in the lowest level of the lattice structure. Advertisement contracts from pools that are parent to the located lowest level pool of advertisement contracts in the lattice structure are added to the set of advertisement contracts, step 450.

Continuing from the previous example, advertising contracts in the pools parent to the pool of advertising contracts targeting California males in age group 18 to 25 years old with an interest in sports located in the lowest level of the lattice structure are added to the set. Therefore, within a lattice structure, such as the one depicted in FIG. 3, parent pools would include the pool of advertisement contracts requiring the constraint of a male person, the pool of advertisement contracts requiring the constraint of a California resident, the pool of advertisement contracts requiring the constraints of a male person and a California resident, the pool of advertisement contracts requiring the constraints of a male person, a California resident and age group 18 to 25 years old and the pool of advertisement contracts requiring the constraints of a male person, a California resident and an interest in sports. The remaining pools of advertisement contracts are then analyzed, step 460. The method of analyzing the remaining pools of advertisement contracts is described in detail with respect to FIG. 5.

FIG. 5 illustrates a flow diagram presenting a method for utilizing a lattice storage structure in an advertisement serving system according to one embodiment of the present invention. In accordance with the embodiment of FIG. 5, the method may begin by analyzing the remaining pools of advertisement contracts located on the same level as the located lowest level pool of advertisement contracts in the lattice structure, step 510. A determination is then made as to whether the remaining pools of advertisement contracts located on the same level satisfy the one or more constraints, step 520. Continuing from the previous example, pools of advertisement contracts located on the same level as the pool of advertisement contracts with constraints of a California male in age group 18 to 25 years old with an interest in sports are analyzed in order to determine whether the remaining pools satisfy one or more constraints.

If one or more of the remaining pools of advertisement contracts located on the same level satisfy the one or more constraints, advertising contracts from the one or more remaining pools are added to the set of advertisement contracts, step 525. If the remaining pools of advertisement contracts located on the same level do not satisfy the one or more constraints, process flow continues to step 530, where the pools of advertisement contracts located on the next higher level of the lattice structure that are not parent to the previously selected pools of advertisement contracts in the lattice structure are analyzed. A determination is made as to whether the pools of advertisement contracts located on next higher level that are not parent to previously selected pools satisfy the one or more constraints, step 540. If the pools of advertisement contracts located on the next higher level that are not parent to the previously selected pools satisfy the one or more constraints, then the advertisement contracts of those pools are added to the set of advertisement contracts, step 545. If the pools of advertisement contracts located on next higher level that are not parent to previously pools do not satisfy the one or more constraints, then process flow returns to step 530.

Continuing from the previous example, as no other pools of advertisement contracts exist on the same level of the lowest level pool of contracts that satisfy the one or more constraints, pools in the next higher levels that were not parents to the previously selected pools are analyzed in order to the determine whether they satisfy one or more constraints. Therefore, within a lattice structure such as the one depicted in FIG. 3, the next pool of advertisement contracts analyzed is the pool of contracts with the constraints of a female person who is a California resident located in Level II, as Level IV did not contain any remaining pools and Level III did not contain any pools of advertisement contracts that were not parent to the previously selected pools. Continuing from the previous example, the pool of advertisement contracts with constraints of a female person who is a California female does not satisfy the one or more constraints because a female person is not a male person. Therefore, the advertisement contracts contained within the pool of advertisement contracts with constraints of a female person who is a California resident is not added to the set of advertisement contracts.

Continuing from the previous example, the pool of advertisement contracts with the single constraint of a female person in Level I of FIG. 3 would next be analyzed as it the only pool left in Level I that is not a parent to the previously selected pools of advertisement contacts. As this pool of advertisement contracts does not satisfy the one or more constraints because again a female person is not a male person, this pool of advertisement contracts is not added to the set of advertisement contracts.

In accordance with the foregoing description, the present invention provides systems, methods and computer program products for utilizing lattice structures in an advertisement serving system. In utilizing lattice constraints in an advertisement serving system, embodiments of the present invention provide solutions to the need for systems and methods that effectively and quickly locate advertisement contracts that can be satisfied when presented with an advertisement opportunity.

FIGS. 1 through 5 are conceptual illustrations allowing for an explanation of the present invention. It should be understood that various aspects of the embodiments of the present invention could be implemented in hardware, firmware, software, or combinations thereof. In such embodiments, the various components and/or steps would be implemented in hardware, firmware, and/or software to perform the functions of the present invention. That is, the same piece of hardware, firmware, or module of software could perform one or more of the illustrated blocks (e.g., components or steps).

In software implementations, computer software (e.g., programs or other instructions) and/or data is stored on a machine readable medium as part of a computer program product, and is loaded into a computer system or other device or machine via a removable storage drive, hard drive, or communications interface. Computer programs (also called computer control logic or computer readable program code) are stored in a main and/or secondary memory, and executed by one or more processors (controllers, or the like) to cause the one or more processors to perform the functions of the invention as described herein. In this document, the terms “machine readable medium,” “computer program medium” and “computer usable medium” are used to generally refer to media such as a random access memory (RAM); a read only memory (ROM); a removable storage unit (e.g., a magnetic or optical disc, flash memory device, or the like); a hard disk; or the like.

Notably, the figures and examples above are not meant to limit the scope of the present invention to a single embodiment, as other embodiments are possible by way of interchange of some or all of the described or illustrated elements. Moreover, where certain elements of the present invention can be partially or fully implemented using known components, only those portions of such known components that are necessary for an understanding of the present invention are described, and detailed descriptions of other portions of such known components are omitted so as not to obscure the invention. In the present specification, an embodiment showing a singular component should not necessarily be limited to other embodiments including a plurality of the same component, and vice-versa, unless explicitly stated otherwise herein. Moreover, applicants do not intend for any term in the specification or claims to be ascribed an uncommon or special meaning unless explicitly set forth as such. Further, the present invention encompasses present and future known equivalents to the known components referred to herein by way of illustration.

The foregoing description of the specific embodiments will so fully reveal the general nature of the invention that others can, by applying knowledge within the skill of the relevant art(s) (including the contents of the documents cited and incorporated by reference herein), readily modify and/or adapt for various applications such specific embodiments, without undue experimentation, without departing from the general concept of the present invention. Such adaptations and modifications are therefore intended to be within the meaning and range of equivalents of the disclosed embodiments, based on the teaching and guidance presented herein. It is to be understood that the phraseology or terminology herein is for the purpose of description and not of limitation, such that the terminology or phraseology of the present specification is to be interpreted by the skilled artisan in light of the teachings and guidance presented herein, in combination with the knowledge of one skilled in the relevant art(s).

While various embodiments of the present invention have been described above, it should be understood that they have been presented by way of example, and not limitation. It would be apparent to one skilled in the relevant art(s) that various changes in form and detail could be made therein without departing from the spirit and scope of the invention. Thus, the present invention should not be limited by any of the above-described exemplary embodiments, but should be defined only in accordance with the following claims and their equivalents.

What is claimed:

1. A method for utilizing a lattice structure in an advertisement serving system to return one or more advertisement contracts, the method comprising:
storing one or more advertisement contracts in a lattice structure;
receiving a request for one or more advertisements that satisfy one or more constraints;
locating, within the lattice structure, a lowest level of one or more pools of advertisement contracts satisfying the one ore more constraints;
generating a set of advertisement contracts, wherein the set of advertisement contracts comprises one or more advertisement contracts from the one or more pools of contracts in the lowest level of the lattice structure that satisfy the one or more constraints;
adding to the set of advertisement contracts one or more advertisement contracts from one or more pools of advertisement contracts that are parent to the one or more pools of contracts in the lowest level of the lattice structure that satisfy the one or more constraints; and
returning one or more advertisement contracts that satisfy the one or more constraints.

2. The method of claim 1, further comprising:
locating one or more pools of advertisement contracts located on next higher levels of the lattice structure that are not parent to previously selected pools that satisfy the one or more constraints;
adding to the set of advertisement contracts one or more advertisement contracts from the one or more pools of advertisement contracts located on next higher levels of the lattice structure that are not parent to previously selected pools that satisfy the one or more constraints.

3. The method of claim 1, wherein the one or more constraints further comprises one or more characteristics of an end user.

4. The method of claim 3, wherein the one or more characteristics of an end user are selected from a group consisting of gender, location, interest, marital status, employment status and nationality.

5. The method of claim 1, wherein returning one or more advertisement contracts that satisfy the one or more constraints comprises:
selecting one or more advertisements associated with the selected one or more advertisement contracts; and
returning the one or more selected advertisements that satisfy that one or more constraints.

6. Computer readable media comprising program code that when executed by a programmable processor causes the programmable processor to execute a method for utilizing a lattice structure in an advertisement serving system, the computer readable media comprising:
program code for storing one or more advertisement contracts in a lattice structure;
program code for receiving a request for one or more advertisements that satisfy one or more constraints;
program code for locating within the lattice structure, a lowest level of one or more pools of advertisement contracts satisfying the one ore more constraints;
program code for generating a set of advertisement contracts, wherein the set of advertisement contracts comprise one or more advertisement contracts from the one or more pools of contracts in the lowest level of the lattice structure that satisfy the one or more constraints;
program code for adding to the set of advertisement contracts one or more advertisement contracts from one or more pools of advertisement contracts that are parent to the one or more pools of contracts in the lowest level of the lattice structure that satisfy the one or more constraints; and
program code for returning one or more advertisement contracts that satisfy the one or more constraints.

7. The computer readable media of claim 6, further comprising:
program code for locating one or more pools of advertisement contracts located on next higher levels of the lattice structure that are not parent to previously selected pools that satisfy the one or more constraints;
program code for adding to the set of advertisement contracts one or more advertisement contracts from the one or more pools of advertisement contracts located on next higher levels of the lattice structure that are not parent to previously selected pools that satisfy the one or more constraints.

8. The computer readable media of claim 6, wherein the one or more constraints further comprises one or more characteristics of an end user.

9. The computer readable media of claim 8, wherein the one or more characteristics of an end user are selected from a group consisting of gender, location, interest, marital status, employment status and nationality.

10. The computer readable media of claim 1, wherein program code for returning one or more advertisement contracts that satisfy the one or more constraints comprises:
program code selecting one or more advertisements associated with the selected one or more advertisement contracts; and
program code for returning the one or more selected advertisements that satisfy that one or more constraints.

11. A system for utilizing a lattice structure in an advertisement serving system, the system comprising:
an advertisement data store operative to store one or more advertisement contracts in a lattice structure;
an advertisement server operative to receive a request for one or more advertisements that satisfy one or more constraints; and
an optimization module operative to:
locate within the lattice structure, a lowest level of one or more pools of advertisement contracts satisfying the one or more constraints;
generate a set of advertisement contracts, wherein the set of advertisement contracts comprise one or more advertisement contracts from the one or more pools of contracts in the lowest level of the lattice structure that satisfy the one or more constraints;
add to the set of advertisement contracts one or more advertisement contracts from one or more pools of advertisement contracts that are parent to the one or more pools of contracts in the lowest level of the lattice structure that satisfy the one or more constraints; and
return one or more advertisement contracts that satisfy the one or more constraints.

12. The system of claim 11, wherein the optimization module is operative to:
locate one or more pools of advertisement contracts located on next higher levels of the lattice structure that are not parent to previously selected pools that satisfy the one or more constraints;
add to the set of advertisement contracts one or more advertisement contracts from the one or more pools of advertisement contracts located on next higher levels of the lattice structure that are not parent to previously selected pools that satisfy the one or more constraints.

13. The system of claim 11, wherein the one or more constraints further comprises one or more characteristics of an end user.

14. The system of claim 13, wherein the one or more characteristics of an end user are selected from a group consisting of gender, location, interest, marital status, employment status and nationality.

15. The system of claim 11, wherein the advertisement server is operative to:
select one or more advertisements associated with the selected one or more advertisement contracts; and
return the one or more selected advertisements that satisfy that one or more constraints.

16. The system of claim 11 wherein the advertisement server is operative to perform the functions of the optimization module.
